(19) United States
(12) Patent Application Publication
(10) Pub. No.: US 2013/0054271 A1
(43) Pub. Date: Feb. 28, 2013

(54) USING QUICK RESPONSE (QR) CODE TO AUTHENTICATE, ACCESS, AND TRANSFER ELECTRONIC MEDICAL RECORD INFORMATION

(71) Applicants: Jessica Joan Langford, Dallas, TX (US); Sari Susan McCoy, Pflugerville, TX (US)

(72) Inventors: Jessica Joan Langford, Dallas, TX (US); Sari Susan McCoy, Pflugerville, TX (US)

(21) Appl. No.: 13/592,269

(22) Filed: Aug. 22, 2012

Related U.S. Application Data
(60) Provisional application No. 61/575,520, filed on Aug. 23, 2011.

(51) Int. Cl. G06Q 50/24

(52) U.S. Cl. 705/3

(57) ABSTRACT

A computer system for generating quick response (QR) codes for patients and healthcare services providers, scanning devices for said QR codes, and a computer program which enables health care service providers and insurers to scan said codes to rapidly identify patients and secure computer access to a web-based electronic medical record for the patient and review and revise said record. The disclosed embodiments provide multiple benefits, including a centralized, real-time electronic medical record to which a patient and any healthcare provider can gain access from any web-enabled computer with a QR code scanning capability.

### CROSS REFERENCE TO RELATED APPLICATIONS

This application claims the benefit of U.S. provisional patent application No. 61/575,520 filed Aug. 23, 2011, having the title “Using Quick Response (QR) Code to Create, Store Access and Transfer Electronic Medical Record Information,” which is incorporated by reference in its entirety.

### BACKGROUND

1. Field of the Disclosure

This disclosure relates generally to data processing, and more specifically to electronic data management.

2. Description of Related Art

As electronic systems become more ubiquitous, there are ongoing efforts directed to managing data in electronic format. Personal data is no exception. In view of the increasing migration toward electronic storage and management of personal data in various environments, there is a need in the art for continued improvement.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 shows one embodiment of a quick-response (QR) code.

FIG. 2 shows one embodiment of a process flow diagram.

FIG. 3 shows one embodiment of four (4) possible processes by which to access the web-based electronic medical record (EMR) database.

FIG. 4 shows one embodiment of a QR Code Scanner with USB connection cable and USB connector.

### DETAILED DESCRIPTION OF THE EMBODIMENTS

Over the past decade, the United States government has encouraged and driven a policy toward converting health care information from paper documents to electronic format, which is more readily available for timely access, sharing, updating, and archiving. Laws, such as the Health Insurance Portability and Accountability Act (HIPAA) and amendments thereto, and more recently the American Recovery and Reinvestment Act (ARRA) which mandates various levels of health information technology advancements in the next several years, have both been enacted to move heath care providers and the supporting industries to digitizing health care information to support electronic medical records (EMRs). Indeed, advances have been made in connecting networks over which such information can be shared, creating linked databases in which the data can be stored, and the associated safeguards to keep such information confidential and accessible only by those with the proper authorization to use the information.

However, while there has been significant progress in converting information into an electronic (sometimes portable) format, there remains a gap in providing immediate, real-time access to a medical record for all interested parties. To date, there are still significant shortfalls in providing patients a portable, electronic medical record. Furthermore, there is no successful, cost efficient solution for providing access to existing medical records by any health care provider who may have had no previous contact with a particular patient, such as when a patient is travelling away from her city of residence, or especially in cases where the patient is unconscious or otherwise unable to communicate their medical history or other needs to a health care provider. Nowhere are these gaps more evident than in emergency rooms (ER) where time is critical to patient welfare.

Lastly, with increasing populations in the United States, the healthcare system is overburdened in attempting to provide substantive medical care, much less taking the time to process (sometime duplicating efforts) intake documents related to contact information, insurance, allergy information, and medical history. Furthermore, with an increasing number of Americans without health insurance having to seek medical care in the ER, such administrative delays are not only impeding timely patient care, they are bringing operations to a crawl, if not breaking the system altogether.

The various embodiments of systems and processes disclosed herein seek to address these issues. For example, one embodiment of a system comprises a computer program, which uses Quick Response (QR) codes to identify patients and their medical records, authenticate health care service or provider credentials, and provides both patients and health care providers access to a web-based EMR. A QR code is a unique two-dimensional code that is readable by computer devices, including but not limited to, desktop computers, tablet computers, and smart phones.

The disclosure presents a method in which such a system generates a patient QR code that is first scanned by a QR-capable client computer device at a healthcare facility or other service location. Upon completion of a scan of the patient QR code, there is a second scan of a QR code assigned to the particular facility. Thereafter, a user-specific identification code and password are entered, and a secure Internet-based connection is made to a health care facility portal through which a patient-generated electronic medical record EMR can be accessed. This EMR comprises medical information including, but not limited to, personal information, medical history, allergies, insurance information, family members, existing medications, and the patient's physician's information. The EMR can be reviewed, revised and updated by authorized parties to include the patient, family members, care givers, physicians and hospital staff, thereby resulting in a complete, up-to-date medical record for both the patient and those working in service and treatment of the patient.

For an individual consumer, the benefits include, but are not limited to, convenience, ease of information retrieval, consolidation of information, time saving, control of personal data, peace of mind, family member assistance, safety, and a decrease in the redundancy of data distribution. For a healthcare provider, the benefits include, but are not limited to, the immediate retrieval of essential information, registration efficiency, expedited evaluation and treatment, a potential for a resulting decrease in medication errors, a decrease in the redundancy of data collection, a decreased wait time for patients, and effective time management of medical staff currently overburdened with paper-based administrative requirements. For an insurance provider, and for all parties related to the healthcare transaction, the benefits include expedited insurance claim review and reimbursements. Collectively, these benefits are a significant cost savings and will likely increase the effectiveness and efficiency of the care provided as staff will be spend less time on administrative duties and be able to focus more on patient care.

With this in mind, reference is now made in detail to the description of the embodiments as illustrated in the drawings, which provide a more-detailed explanation of the inventive concepts. While several embodiments are described in connection with these drawings, there is no intent to limit the disclosure to the embodiment or embodiments disclosed herein. On the contrary, the intent is to cover all alternatives, modifications, and equivalents.

### A. QR Code

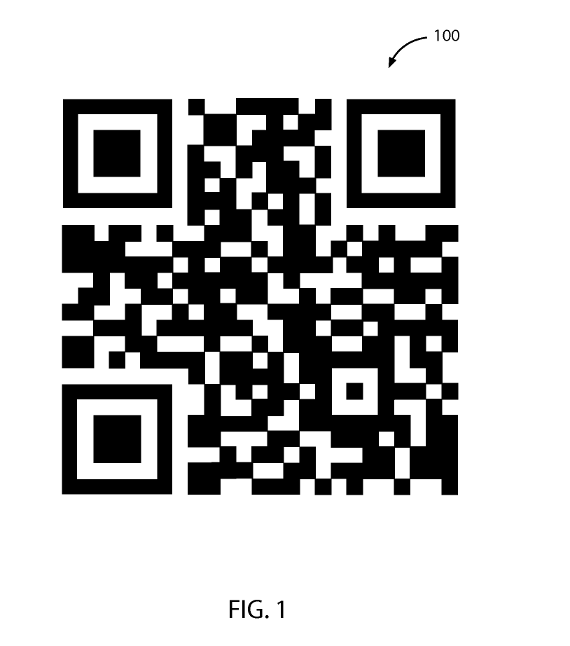

Referring now to the drawings in more detail, FIG. 1 shows a quick response (QR) code 100 comprising a computer-readable pattern. A QR code is a unique two-dimensional code that is readable by computer devices, including but not limited to, desktop computers, tablet computers, and smart phones. A QR code includes black modules arranged in a square pattern on a white background and can be created by any commercially available application which generates QR codes from data sets.

As shown in FIG. 1, one embodiment of a QR code 100 is shown as being approximately 1-inch-by-1-inch in size. By way of example, such a sized QR code can be printed on plastic, clear laminate or any material which enables the QR code to be read by QR-capable computer devices, including but not limited to, desktop computers, tablet computers, and smart phones. Insofar as QR codes are known in the art, only a truncated discussion of QR codes is provided herein. It is the scanning of this QR code by a QR-capable computer device that initiates the processes described below.

### B. Computer Program

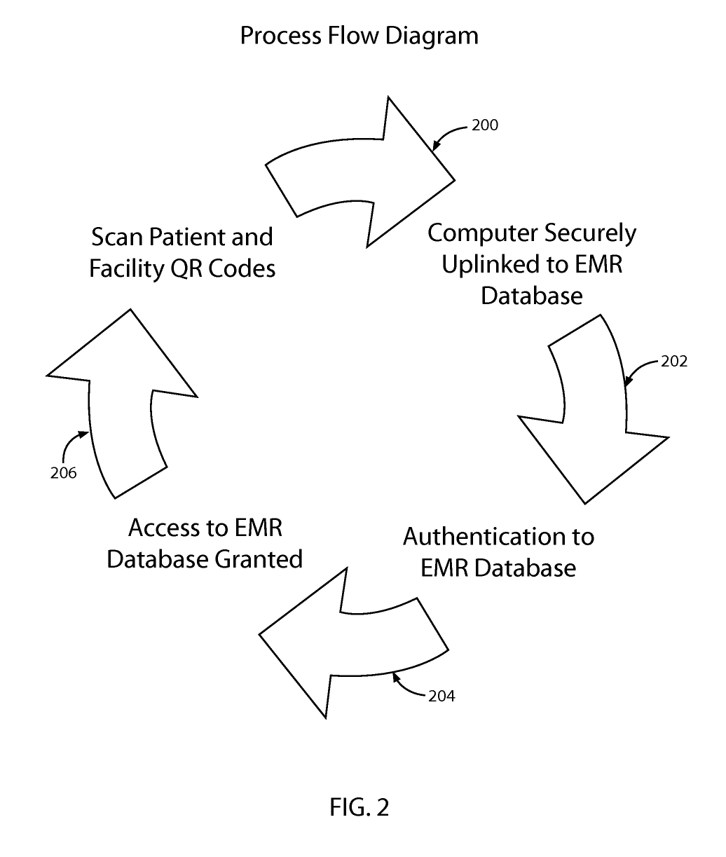

The disclosed embodiment of the computer program facilitates access to EMRs by directing a facility client computer processor to complete at least four steps¹. FIG. 2 shows those steps, through which the disclosed computer program authenticates any facility in providing that facility with access to a patient's EMR stored on a centralized database. A facility can be one of many health care entities, including, but not limited to, a health care system (“HCS”) such as a hospital or network of hospitals, a primary care provider (“PCP”), an insurance provider, or other health care service provider entity. For purposes of illustrating the processes below, an HCS will be used as the facility. ¹In this section, a narrative form and pseudocode is provided to describe the computer program's instructions in simplified terms. The full source code of each of the four steps described are provided at the end of the written description in accordance with MPEP Appendix R, §1.96(b)(ii).

As shown in FIG. 2, the first step 200 comprises a facility scanning a QR code by a QR capable device. In this embodiment, a QR code that is presented by a patient upon arrival at a facility is first scanned by a HCS user employee (“employee”) on a QR-capable client computer device, using a USB QR code scanner (“QR Code Scanner”) or other comparable device that is connected to the facility computer with a USB cable and USB connector.

In this first step 200 of FIG. 2, the computer program on the facility computer presents a Patient Identification (ID) Code text box, a Facility ID Code text box, and a “Find Patient” icon on a user interface (UI) on a computer monitor. If the Patient ID Code text box is empty, then the program waits for the employee to enter the Patient ID Code. The employee enters the Patient ID Code by selecting the Patient ID Code text box and scanning a patient QR code. In a preferred embodiment, the Patient ID Code text box populates with the Patient ID Code when the employee scans the patient QR code.

In a preferred embodiment, the program starts a timer when a first character is entered into the Patient ID Code text box, and refreshes the timer every time that a new character is entered into the Patient ID Code text box, until the entire Patient ID has been entered into the text box. One way the disclosed program determines whether the entire Patient ID Code has been entered is by tracking the elapsed time on the timer. So, for example, if no additional characters are entered for a fixed period of time (e.g., one second), then this may be an indication that the entire Patient ID has been entered.

Once the entire Patient ID Code has been entered in its entirety, the program preferably moves the cursor to the Facility ID Code text box. If the Facility ID Code text box is empty, then the program waits for the employee to enter the Facility ID Code. The employee enters the Facility ID Code by scanning a facility QR code. The scanning of the facility QR code populates the Facility ID Code text box. Again, in a preferred embodiment, the program again starts a timer when a first character is entered into the Facility ID Code text box, and refreshes the timer every time that a new character is entered into the Facility ID Code text box, until the entire Facility ID Code has been entered into the text box. Similar to the Patient ID Code the program can determine whether the entire Facility ID Code has been entered by tracking the elapsed time on the timer.

After scanning both the patient QR code and the facility QR code, the employee selects the “Find Patient” icon on the UI. In an alternative embodiment, the employee may simply hit the “enter” key on the keyboard. Upon receiving either the “Find Patient” selection or an entry command, the computer program directs the client facility computer to launch the computer's Internet web browser, thereby opening the facility's portal site.

In the second step 202 of FIG. 2, the QR capable device securely uplinks to an EMR database, which holds EMRs for numerous patients. Specifically, after the HCS employee clicks on the Find Patient button or presses enter/return enter, the program creates an object in which to store the Patient ID Code and the Facility ID Code and the current date and time. This is done by retrieving the Patient ID Code from the Patient ID Code text box and saving the Patient ID Code in the object. Similarly, the program retrieves the Facility ID Code from the Facility ID Code text box and saves the Facility ID Code in the object. The current date and time is stored in the object prior to the object being sent to the facility portal site.

Once all of this data is saved, the program converts the object into a serialized byte array and preferably encodes the object into a Base64 string. The program then constructs a universal resource locator (URL) string for a facility portal domain, and adds the encoded object as a parameter to the URL string. This results in a URL that includes, among other things, information about the patient and the facility. The program then opens an Internet web browser on the HCS client computer, and navigates the web browser to the URL, thereby concluding the second step 202 of FIG. 2.

In the third step 204 of FIG. 2, the HCS client computer and the web site opened at the completion of second step of FIG. 2 is authenticated via a user-specific identification code and password. Specifically, the Internet web page of the constructed URL is opened by the client HCS computer. On the computer monitor, the computer program presents the HCS employee with a facility portal login view with two text boxes on its, one for the HCS employee's e-mail address (or other employee identifier) and one for the HCS employee user's password. At this prompt, the HCS employee manually enters the employee identifier (e.g., email address) and password. Once both the identifier and password are entered, the employee selects a “Log In” icon, preferably situated below the two text boxes. Upon selection of the “Log In” button, the computer program instructs the facility computer to authenticate the HCS employee with the EMR database.

For some embodiments, this third step 204 of FIG. 2. continues with the program retrieving the encoded object from the URL. If no encoded object is present in the URL, then the authorization process fails. However, if the encoded object is present in the URL, then the object is retrieved, decoded, and converted to a serialized byte array. The program then de-serializes the array to extract the Patient ID Code and the Facility ID Code, and the original date and time provided by the program at the time the QR codes are first scanned, as well as retrieve the email address and the password from the login screen on the Internet web site.

If the email address exists in the database; and

If the email address and password combination exists in the database; and

the facility code in the object matches the facility code of the employee in the database; and

the difference between the current date and time and the date and time saved in the object is less than 10 minutes; then

the program authorizes the employee to log in to the facility portal.

In the fourth step 206 of FIG. 2, access to the EMR database through the facility portal is granted, and the HCS employee is able to access data already entered by the patient, or other entities that are likewise authorized to access and revise information in the EMR.

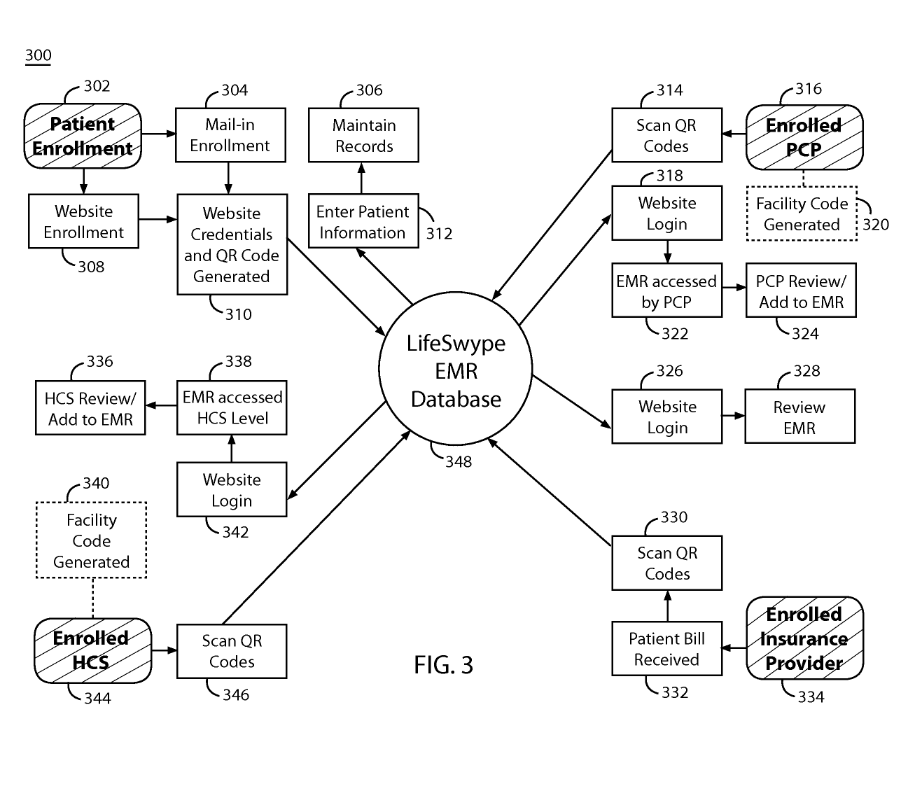

Referring now to FIG.3 in detail, one embodiment of the EMR database is presented with four (4) processes by which the database can be accessed. In one embodiment, the centralized EMR database 348 is hosted by a single company, whose staff works to enroll both patients 302 and health care service providers (316, 344, and 334) in a company-provided commercial EMR service.² ²The company name, “Lifeswype”, as presented in FIG. 3, is a federally registered trademark of the applicant inventors' company, LifeSwype, LLC.

Patient enrollment 302 commences by one of two possible enrollment means. First, patients can enroll in the EMR service by submitting patient enrollment information via regular U.S. mail to the company 304. Secondly, in an alternate embodiment, patients can enroll through a separate company website 308 where they likewise provide patient enrollment information. In either enrollment process 304 or 308, the patient's enrollment information is used by the company to both create login credentials and generate the patient's QR code comprising the Patient ID Code 310. Using a commercially available software application for generating QR codes from data sets, the company generates the QR code comprising the Patient ID Code to pair with the EMR database 348. The company then creates a patient EMR in the EMR database 348. In one embodiment, this EMR contains web pages linked to EMR Database 348 tables such as, but not limited to, “Personal Information”, “Payment Method”, “Account Management”, “Insurance”, “Allergies”, “Medications”, “Surgical History” and “Family History”. The EMR also can also include attached documents supporting the entries in the EMR database tables through these web pages. After creating the patient's EMR profile in the EMR database 348, the company then provides the patient his web site credentials and QR Code. As described with reference to FIG. 1, in one embodiment, a QR code 100 can be printed directly on a plastic card or on a clear laminate which can be applied to an existing card, such as the patient's medical insurance card or personal identification card. Provided with a QR code 100, the associated Patient ID code, as well as a web-based ID and password to access the EMR database 348, the patient can then manually enter information into the applicable fields in his EMR stored in the EMR database 348. At any time thereafter, the patient can return to the company web site, and, using the same web site login credentials (ID and password), access and maintain his EMR 306 to ensure accurate and timely information is available.

Likewise, interested health service providers, such as primary care physicians (PCP) or health care systems (HCS), can enroll in the company's EMR service. FIG. 3 presents an embodiment where the company creates and provides a facility code for a PCP 316 or for a HCS 340. Using a commercially available software application for generating QR codes from data sets, the company generates the QR code comprising a facility code to pair with the EMR database 348. After creating the PCP or HCS profile in the EMR database, to include complete lists of each service provider's authorized employee users, the company then provides the service provider its credentials and facility QR code. After these steps are completed, each service provider is enrolled and able to access the EMR information stored in the EMR Database 348 as described below.

FIG.3 presents one embodiment in which an enrolled PCP's office 316 is visited by a patient possessing an enrolled QR code. The patient's QR code and the PCP's facility code are scanned 314 by the PCP employee using a QR Code Scanner attached to a facility QR-capable computer device. As described in the second step of FIG. 2, this QR code is uplinked via a secure Internet-based connection to an EMR database 348 containing the visiting patient's EMR. The PCP's client computer device authenticates to the EMR central database server as previously disclosed in the third step of FIG. 2 in which the employee enters an authorized e-mail and password 318. Once authentication is complete and database access granted 322 as described in the fourth step of FIG. 2, the PCP employee can access, review and revise the patient's EMR stored on the EMR database 348.

FIG. 3 presents another embodiment in which an enrolled HCS 344 is visited by a patient possessing an enrolled QR code. The patient's QR code and the HCS's facility code are scanned 346 by the HCS using a QR Code Scanner attached to a facility QR-capable computer device. As described in the second step of FIG. 2, this QR code is uplinked via a secure Internet-based connection to an EMR database 348 containing that patient's EMR. The HCS's client computer device authenticates to the EMR central database server as previously disclosed in the third step of FIG. 2 in which the employee enters an authorized e-mail and password 342. Once authentication is complete and database access granted 338 as described in the fourth step of FIG. 2, the HCS employee can access, review and revise patient's EMR stored in the EMR database 348.

FIG. 3 depicts another embodiment of such a transaction in which the enrolled facility is a Health Insurance Provider 334. In this embodiment, when the Insurance Provider receives a bill for patient treatment labeled with the patient's QR code 332, the patient's QR code is scanned 330. In another embodiment, the Insurance Provider can likewise receive a patient application for policy coverage with a patient QR code likewise affixed. As described in the second step of FIG. 2, this QR code is uplinked via a secure Internet-based connection to a centralized EMR database 348 containing that patient's EMR. The Insurer Provider's client computer device authenticates to the EMR central database server as previously disclosed in the third step of FIG. 2 in which the employee enters an authorized e-mail and password 326. Once authentication is complete and database access granted as described in the fourth step of FIG. 2, the Insurance Provider employee can access and review and the patient's EMR 328 stored in the EMR database 348.

### C. Preferred Hardware Embodiment

Discussing the preferred hardware embodiment in finer granularity, the preferred embodiment comprises a computer system having a web application, a database, a reporting and email service, and a user authentication program.

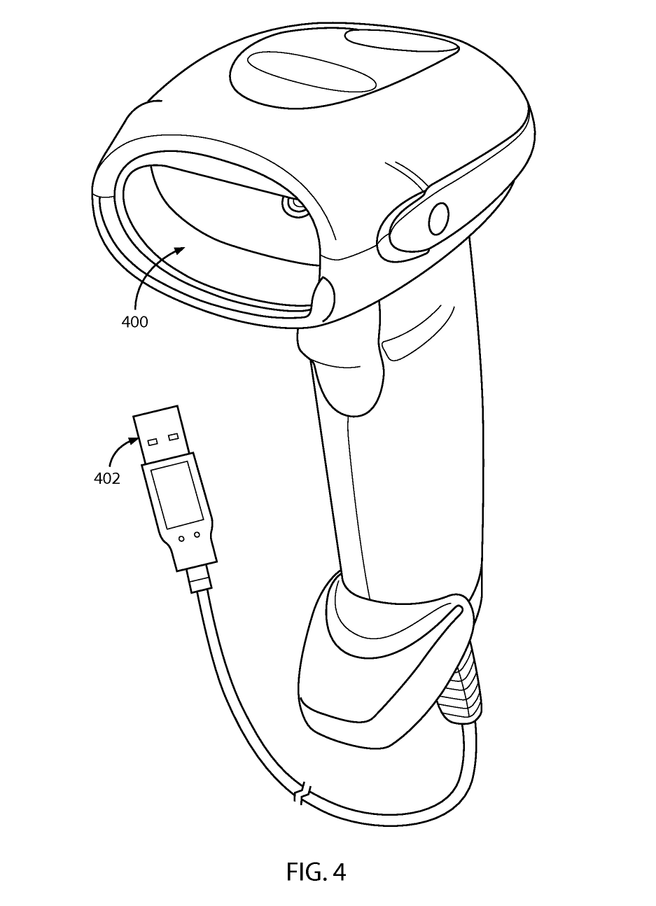

The facility client computer is preferably a personal computer (PC) or laptop device running Windows software. FIG. 4 shows one embodiment of a QR Code Scanner 400. A QR Code Scanner 400 is used to scan and translate the QR code presented by the patient and facility QR codes. The QR Code Scanner 400 connects to a facility QR capable device via a USB cable connector 402. The QR Code Scanner disclosed in this embodiment can be any commercially available handheld QR capable code reader that is connectable via a USB cable and connector to a facility computer running the disclosed computer program. This disclosure also includes a mouse replacement/supplement pad, which enables the facility user to sign directly on to a control on the webpage. A printer is optionally available to print generated documents.

The web application is intended to be user friendly. Thus, with respect to the user experience in the web-based embodiment, web pages are implemented with Telerik ASP.NET Ajax Controls Q4 2010+ (“Telerik”). Web pages are controlled by Telerik, whenever available, for optimal user experience and a consistent, flexible user interface. In an alternative embodiment, when Telerik is not available, the recommended solution is an ASP.NET Toolkit, or other custom user controls. The preferred embodiment of the Internet web browser is Internet Explorer 8 or higher, although some functions might not be available to other browsers. Web formatting coding for the facility (client) side web formatting and coding is preferably actualized by Jscript 5.8+, jQuery 1.4.4+, CSS 2.1, or any combination thereof.

Next, in its preferred embodiment, the EMR database is an optimally normalized relational SQL database hosted by Microsoft SQL Server 2008 and accessed through SQL Authentication by the application instance. LLBL 3.3+ ORM is preferably used to facilitate database communication and use. Complex SQL queries are preferably converted to Procedures, Views, or Typed Lists wherever appropriate and called through LLBL.

The system reporting is preferably done through Microsoft SQL Server Reporting Services 2008 and is made accessible to the facility user through Microsoft Report Viewer 2010 (for reports which are embedded or are only one page) and through the native PDF viewer for combined reports. Reports are preferably combined to one PDF on the server using, for example, itextsharp. Email is sent through SMTP or other known email protocol. Any documents, which are a product of the embodiments described herein, are generated on demand through use of stored database values, and there is preferably no need for these documents to be stored on the server.

In the preferred embodiment, user role-based access profiles, permissions, and access are managed by ASP.NET Role and Membership Providers, and users can access the secure portions of the website through a login page which integrates with the ASP.NET Authentication.

The various embodiments of the systems, as described herein, may be implemented in hardware, software, firmware, or a combination thereof. In the preferred embodiment(s), the disclosed systems are implemented in software or firmware that is stored in a memory and that is executed by a suitable instruction execution system. If implemented in hardware, as in an alternative embodiment, the disclosed systems can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Any process descriptions or blocks in flow charts should be understood as representing modules, segments, or portions of code which include one or more executable instructions for implementing specific logical functions or steps in the process, and alternate implementations are included within the scope of the preferred embodiment of the present disclosure in which functions may be executed out of order from that shown or discussed, including substantially concurrently or in reverse order, depending on the functionality involved, as would be understood by those reasonably skilled in the art of the present disclosure.

The software embodiments, as described herein, can be written as a computer program, which comprises an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a non exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium, upon which the program is printed, as the program can be electronically captured via, for instance, optical scanning of the paper or other medium, then compiled, interpreted or otherwise processed in a suitable manner if necessary, and then stored in a computer memory. Although exemplary embodiments have been shown and described, it will be clear to those of ordinary skill in the art that a number of changes, modifications, or alterations to the disclosure as described may be made. All such changes, modifications, and alterations should therefore be seen as within the scope of the disclosure.

Computer Program Source Code for First and Second Steps of FIG. 2

```
namespace LifeSwype.BarcodeScanner
{
  /// <summary>
  /// Interaction logic for MainWindow.xaml
  /// </summary>
public partial class MainWindow : Window
  {
private DispatcherTimer ScanTimer = new DispatcherTimer( );
    public MainWindow( )
    {
      InitializeComponent( );
      txtPatientCode.Focus( );
      ScanTimer.Tick += new EventHandler(ScanTimer_Tick);
    }
    #region Private Methods
    private void QRCodeChanged(string changedControl)
    {
      ScanTimer.Stop( );
      ScanTimer.Tag = changedControl;
      ScanTimer.Interval = new TimeSpan(0, 0, 1);
      ScanTimer.Start( );
    }
    #endregion
    #region Event Handlers
    private void btnFind_Click(object sender, RoutedEventArgs e)
    {
      FacilityScannerIntegrator integrator = new
      FacilityScannerIntegrator( );
      integrator.PatientID =
      Base64Converter.Convert64ToGuid(txtPatientCode.Password);
      integrator.FacilityID =
      Base64Converter.Convert64ToGuid(txtFacilityCode.Password);
      integrator.ValidationDate = DateTime.Now;
      string encodedValidation = “”;
      using (MemoryStream ms = new MemoryStream( ))
      {
        BinaryFormatter formatter = new BinaryFormatter( );
        formatter.Serialize(ms, integrator);
        encodedValidation =
      Base64Converter.ConvertToUrlSafeBase64(ms.ToArray( ));
      }
      string facilityURL = string.Format(“{0}Login.aspx?auth={1}”,
      ConfigurationSettings.AppSettings[“FacilityPortalHostUrl”],
encodedValidation)
      //Use this to open the web page in a specific browser
      //Process.Start(“iexplore.exe”, facilityURL);
      //Use this to open the web page in the system's default browser
      Process.Start(facilityURL);
      }
      private void btnReset_Click(object sender, RoutedEventArgs e)
      {
      txtPatientCode.IsEnabled = true;
      txtFacilityCode.IsEnabled = true;
      txtPatientCode.Password = String.Empty;
      txtFacilityCode.Password = String.Empty;
      txtPatientCode.Focus( );
        }
      private void txtPatientCode_PasswordChanged(object sender,
RoutedEventArgs e)
      {
      if (!string.IsNullOrWhiteSpace(txtPatientCode.Password))
        QRCodeChanged(“PatientChange”);
      }
      private void txtFacilityCode_PasswordChanged(object sender,
RoutedEventArgs e)
      {
      if (!string.IsNullOrWhiteSpace(txtFacilityCode.Password))
        QRCodeChanged(“FacilityChange”);
      }
      private void ScanTimer_Tick(object sender, EventArgs e)
      {
      DispatcherTimer dt = (DispatcherTimer)sender;
      dt.Stop( );
      switch (dt.Tag.ToString( ))
      {
        case “PatientChange”:
          txtPatientCode.IsEnabled = false;
          txtFacilityCode.Focus( );
          break;
        case “FacilityChange”:
          txtFacilityCode.IsEnabled = false;
          btnFind.Focus( );
          break;
      }
      }
    #endregion
      }
```

Computer Program Source Code for Third and Fourth Steps of FIG. 2

```
        private bool AuthenticateEmployee( )
        {
            bool authenticated = false;
            if
(!string.IsNullOrWhiteSpace(Request.QueryString[“auth”]))
        {
        //get the patient and facility details provided by the scanner.
        string encodedValidation = Request.QueryString[“auth”];
        FacilityScannerIntegrator scannerIntegrator = new
                FacilityScannerIntegrator( );
        using (MemoryStream stream = new MemoryStream( ))
        {
        byte[ ] decodedArray =
        Base64Converter.Convert64ToByteArray(encodedValidation);
        stream.Write(decodedArray, 0, decodedArray.Length);
        stream.Seek(0, SeekOrigin.Begin);
        BinaryFormatter deserializeFormatter = new BinaryFormatter( )
        scannerIntegrator
          =
(FacilityScannerIntegrator)deserializeFormatter.Deserialize(stream);
        }
        HealthCareProviderEmployeeCollection
healthCareEmployeeColl = new
HealthCareProviderEmployeeCollection( );
        PredicateExpression filter = new PredicateExpression( );
        filter.AddWithAnd(HealthCareProviderEmployeeFields.Email ==
                EmployeeLogin.UserName);
        filter.AddWithAnd(HealthCareProviderEmployeeFields.-
Active == true);
        healthCareEmployeeColl.GetMulti(filter)
        if (healthCareEmployeeColl.Count > 0)
        {
        if
    (healthCareEmployeeColl[0].HealthCareProviderId.-
Equals(scannerIntegrator.FacilityID)
            && DateTime.Now <=
scannerIntegrator.ValidationDate.AddMinutes(10)
            && Authentication.VerifyHash(EmployeeLogin.Password,
healthCareEmployeeColl[0].PasswordSalt,
healthCareEmployeeColl[0].Password))
        {
          authenticated = true;
          Session[“HealthCareProviderEmployeeID”] =
healthCareEmployeeColl[0].HealthCareProviderEmployeeId;
          Session[“PatientID”] = scannerIntegrator.PatientID;
            if (Session[“RedirectURL”] != null &&
!string.IsNullOrWhiteSpace(Session[“RedirectURL”].ToString( )))
              Response.Redirect(Session[“RedirectURL”].ToString( ));
            else
              Response.Redirect(“~/PatientDetailsReport.aspx”);
          }
        }
      }
      return authenticated;
    }
```

What is claimed is:

1. A computer system, comprising:
a quick response (QR) code scanner to scan a patient QR code, the QR code scanner further to scan a facility QR code; and a non-transient computer-readable medium, comprising:
computer-readable code to detect a scan of a patient QR code;
computer-readable code to populate a patient identification (ID) code in a Patient ID field in response to detecting the scan of the patient QR code;
computer-readable code to detect a scan of a facility QR code;
computer-readable code to populate a facility ID code in a facility ID field in response to detecting the scan of the facility QR code;
computer-readable code to receive user login information;
computer-readable code to query a server database to determine whether the server database comprises the patient ID code;
computer-readable code to query a server database to determine whether the server database comprises the facility ID code;
computer-readable code to query a server database to determine whether the server database comprises the user login information; and
computer-readable code to allow access to a patient electronic medical record in response to determining that server database comprises:
the Patient ID code;
the facility ID code; and
the user login information.

2. A method, comprising:
detecting a scan of a patient QR code;
populating a patient identification (ID) code in a patient ID field in response to detecting the scan of the patient QR code;
detecting a scan of a facility QR code;
populating a facility ID code in a facility ID field in response to detecting the scan of the facility QR code;
receiving user login information;
querying a server database to determine whether the server database comprises the patient ID code;
querying a server database to determine whether the server database comprises the facility ID code;
querying a server database to determine whether the server database comprises the user login information; and
allowing access to a patient electronic medical record in response to determining that server database comprises:
the patient ID code;
the facility ID code; and
the user login information

3. A method, comprising:
detecting a scan of a patient QR code, the patient QR code comprising a patient identification (ID);
detecting a scan of a facility QR code, the facility QR code comprising a facility ID;
receiving user login information;
querying a server database to determine whether the server database comprises the patient ID, the facility ID, and the user login information; and
allowing access to a patient electronic medical record in response to determining that server database comprises the patient ID code, the facility ID code, and the user login information.
